(19) United States
(12) Patent Application Publication
(10) Pub. No.: US 2012/0238349 A1
(43) Pub. Date: Sep. 20, 2012

(54) Method of Gaming, a Game Controller and a Gaming System

(76) Inventor: Sek Hwan Joung, North Rocks (AU)

(21) Appl. No.: 13/420,174

(22) Filed: Mar. 14, 2012

(30) Foreign Application Priority Data
Mar. 15, 2011 (AU) 2011900927

(51) Int. Cl. A63F 13/00; A63F 13/02

(52) U.S. Cl. 463/22

(57) ABSTRACT

A method of gaming in a gaming system comprises conducting a game event collection game for a player and storing data in a memory in response to occurrence of the game event in a game round, the data enabling a determination of an average amount wagered in respect of each game round in which a game event occurred. The method involves generating a game outcome for each game round by controlling a probability of the game event occurring in each game round by determining a current probability of the game event occurring to apply to a current game round, prior to and subsequent to a game event occurring, based on an amount wagered in respect of the current game round and the average amount wagered.

### RELATED APPLICATIONS

This application claims priority to Australian Provisional Patent Application No. 2011900927, having an International filing date of Mar. 15, 2011, which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

It is known to provide a game in which a player of a gaming machine seeks to collect a designated number of symbols across a plurality of games played on the gaming machine to thereby obtain an award.

While such games provide players with enjoyment, a need exists for alternative gaming systems in order to maintain or increase player enjoyment.

### BRIEF SUMMARY OF THE INVENTION

In a first aspect, the invention provides a method of gaming in a gaming system, the method comprising:
conducting a game event collection game in which a player seeks to collect a designated number of a game event across a plurality of game rounds conducted with the gaming system to thereby obtain an award affected by an amount wagered in a game round in which the designated number of game events is reached;
storing data in a memory of the gaming system in response to occurrence of the game event in a game round, the data enabling a determination of an average amount wagered in respect of each game round in which a game event occurred;
generating a game outcome for each game round by controlling a probability of the game event occurring in each game round by determining a current probability of the game event occurring to apply to a current game round, wherein (i) prior to a game event occurring, the current probability is determined to be a base probability; and (ii) subsequent to a game event occurring, the current probability is determined based on an amount wagered in respect of the current game round and the average amount wagered; and
making the award upon the designated number of game events being reached.

In an embodiment, the method comprises determining whether to make one or more other awards in respect of each game outcome.

In an embodiment, the award comprises conducting a series of free game rounds and determining whether to make any free game round awards, wherein the quantum of each free game round award is affected by the amount wagered in the game round in which the designated number of game events were collected.

In an embodiment, the free game rounds are different to the game round in which the game events are collected.

In an embodiment, the quantum of the award is affected by the amount wagered in a game round in which the designated number of game events is reached.

In an embodiment, the step of storing data comprises storing each amount wagered when a game event occurred to thereby enable the average amount wagered to be determined.

In an embodiment, the step of storing data comprises determining and storing an updated average amount wagered in response to each game event occurring.

In an embodiment, the step of storing data further comprises storing the current probability when a game event occurred and wherein the step of determining the current probability subsequent to a game event occurring is based on the current probability is performed based on the stored current probability data

In an embodiment, the method comprises initiating a new game event collection game in response to making the award.

In a second aspect, the invention provides a game controller for a gaming system, the game controller arranged to:
conduct a game event collection game in which a player seeks to collect a designated number of a game event across a plurality of game rounds conducted with the gaming system to thereby obtain an award affected by an amount wagered in a game round in which the designated number of game events is reached;
store data in a memory of the gaming system in response to occurrence of the game event in a game round, the data enabling a determination of an average amount wagered in respect of each game round in which a game event occurred;
generate a game outcome for each game round by controlling a probability of the game event occurring in each game round by determining a current probability of the game event occurring to apply to a current game round, wherein (i) prior to a game event occurring, the current probability is determined to be a base probability; and (ii) subsequent to a game event occurring, the current probability is determined from the base probability, an amount wagered in respect of the current game round, and the average amount wagered; and
make the award upon the designated number of game events being reached.

In an embodiment, the game controller is arranged to determine whether to make one or more other awards in respect of each game outcome.

In an embodiment, the award comprises the game controller conducting a series of free game rounds and determining whether to make any free game round awards, wherein the quantum of each free game round award is affected by the amount wagered in the game round in which the designated number of game events were collected.

In an embodiment, the free game rounds are different to the game rounds in which the game events are collected.

In an embodiment, the quantum of the award is affected by the amount wagered in a game round in which the designated number of game events is reached.

In an embodiment, the game controller stores each amount wagered when a game event occurred to thereby enable the average amount wagered to be determined.

In an embodiment, the game controller stores data by determining and storing an updated average amount wagered in response to each game event occurring.

In an embodiment, the game controller stores the current probability when a game event occurred and the game controller determines the current probability subsequent to a game event occurring based on the stored current probability data.

18.A game controller as claimed in any one of claims 10 to 17, arranged to initiate a new game event collection game in response to making the award.

In a third aspect, the invention provides a gaming system comprising:
a display;
a memory;
a collection controller arranged to:
   conduct a game event collection game in which a player seeks to collect a designated number of a game event across a plurality of game rounds conducted with the gaming system to thereby obtain an award affected by an amount wagered in a game round in which the designated number of game events is reached,
   store data in the memory of the gaming system in response to occurrence of the game event in a game round, the data enabling a determination of an average amount wagered in respect of each game round in which a game event occurred, and
   make the award upon the designated number of game events being reached; and
a probability determiner arranged to determine a current probability of a game event occurring to apply to a current game round, wherein (i) prior to a game event occurring, the current probability is determined to be a base probability; and (ii) subsequent to a game event occurring, the current probability is determined from the base probability, an amount wagered in respect of the current game round, and the average amount wagered;
an outcome generator arranged to generate a game outcome based on the current probability of the game event occurring for display on the display.

In an embodiment, the gaming system comprises an outcome evaluator arranged to determine whether to make one or more other awards in respect of each game outcome.

In an embodiment, the award comprises the outcome generator conducting a series of free game rounds and the outcome evaluator determining whether to make any free game round awards, wherein the quantum of each free game round award is affected by the amount wagered in the game round in which the designated number of game events were collected.

In an embodiment, the free game rounds are different to the game rounds in which the game events are collected.

In an embodiment, the quantum of the award is affected by the amount wagered in a game round in which the designated number of game events is reached.

In an embodiment, the collection controller stores each amount wagered when a game event occurred to thereby enable the average amount wagered to be determined.

In an embodiment, the collection controller stores data by determining and storing an updated average amount wagered in response to each game event occurring.

In an embodiment, the collection controller stores the current probability when a game event occurred and the probability determiner determines the current probability subsequent to a game event occurring based on the stored current probability data.

In an embodiment, the gaming system is arranged to initiate a new game event collection game in response to making the award.

In a fourth aspect, the invention provides a gaming system comprising:
means for conducting a game event collection game in which a player seeks to collect a designated number of a game event across a plurality of game rounds conducted with the gaming system to thereby obtain an award affected by an amount wagered in a game round in which the designated number of game events is reached;
means for storing data in a memory of the gaming system in response to occurrence of the game event in a game round, the data enabling a determination of an average amount wagered in respect of each game round in which a game event occurred;
means for generating a game outcome for each game round by controlling a probability of the game event occurring in each game round by determining a current probability of the game event occurring to apply to a current game round, wherein (i) prior to a game event occurring, the current probability is determined to be a base probability; and (ii) subsequent to a game event occurring, the current probability is determined from the base probability, an amount wagered in respect of the current game round, and the average amount wagered; and
means for making the award upon the designated number of game events being reached.

In a fifth aspect, the invention provides computer program code which when executed implements the above method.

In a sixth aspect, the invention provides a tangible computer readable medium comprising the above program code.

### BRIEF DESCRIPTION OF SEVERAL VIEWS OF THE DRAWINGS

An exemplary embodiment of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system; and

FIG. 7 is a flow chart of an embodiment.

### DETAILED DESCRIPTION OF THE INVENTION

Referring to the drawings, there is shown a gaming system having a game controller arranged to implement a game where a player seeks to collect game events, such as symbols, across a plurality of game rounds (e.g. a plurality of plays of a gaming machine). In the embodiment, the probability of the game event occurring in the current game round is controlled based on the wagers placed in past game rounds where the game event occurred. Advantageously, this enables an award to be provided for the collection game which is affected by an amount wagered in a game round in which the designated number of game events is reached.

### General Construction of Gaming System

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

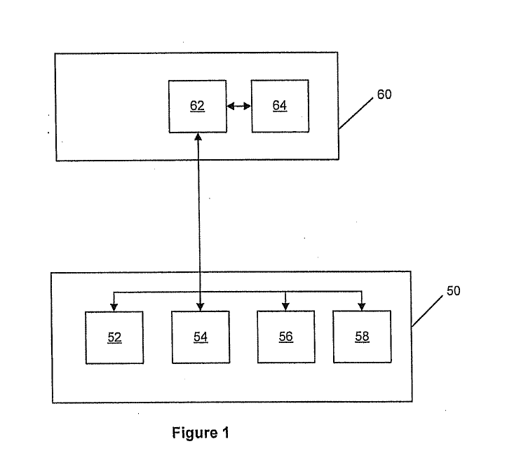

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions to play the game and observe the game outcomes.

Components of the player interface may vary from embodiment to embodiment but will typically include a credit mechanism 52 to enable a player to input credits and receive payouts, one or more displays 54, a game play mechanism 56 including one or more input devices that enable a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play rules are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor using an application specific integrated circuit (ASIC) or a field programmable gate array (FPGA).

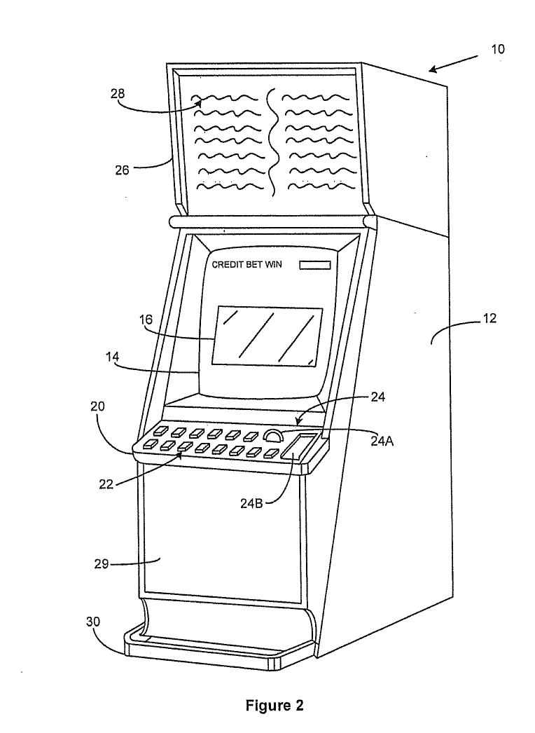

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. Other gaming machines may configure for ticket in such that they have a ticket reader for reading tickets having a value and crediting the player based on the face value of the ticker. A player marketing module (not shown) having a reading device may also be provided for the purpose of reading a player tracking device, for example as part of a loyalty program. The player tracking device may be in the form of a card, flash drive or any other portable storage medium capable of being read by the reading device. In some embodiments, the player marketing module may provide an additional credit mechanism, either by transferring credits to the gaming machine from credits stored on the player tracking device or by transferring credits from a player account in data communication with the player marketing module.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

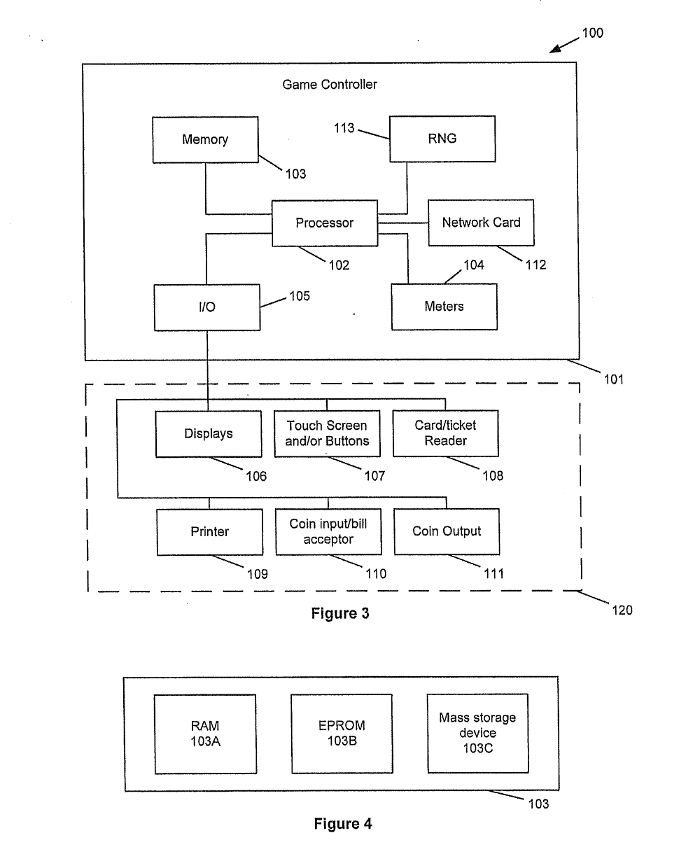

FIG. 3 shows a block diagram of operative components of a typical gaming machine which may be the same as or different to the gaming machine of FIG. 2.

The gaming machine 100 includes a game controller 101 having a processor 102 mounted on a circuit board. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107 (which provide a game play mechanism), a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation. For example, while buttons or touch screens are typically used in gaming machines to allow a player to place a wager and initiate a play of a game any input device that enables the player to input game play instructions may be used. For example, in some gaming machines a mechanical handle is used to initiate a play of the game. Persons skilled in the art will also appreciate that a touch screen can be used to emulate other input devices, for example, a touch screen can display virtual buttons which a player can “press” by touching the screen where they are displayed.

In addition, the gaming machine 100 may include a communications interface, for example a network card 112. The network card may, for example, send status information, accounting information or other information to a bonus controller, central controller, server or database and receive data or commands from the bonus controller, central controller, server or database. In embodiments employing a player marketing module, communications over a network may be via player marketing module—i.e. the player marketing module may be in data communication with one or more of the above devices and communicate with it on behalf of the gaming machine.

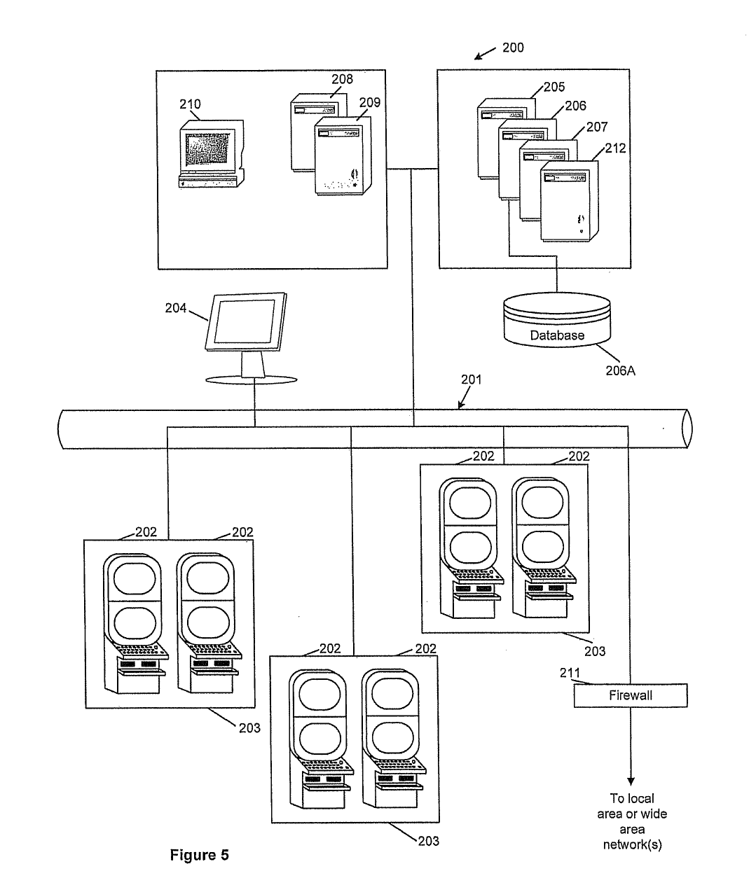

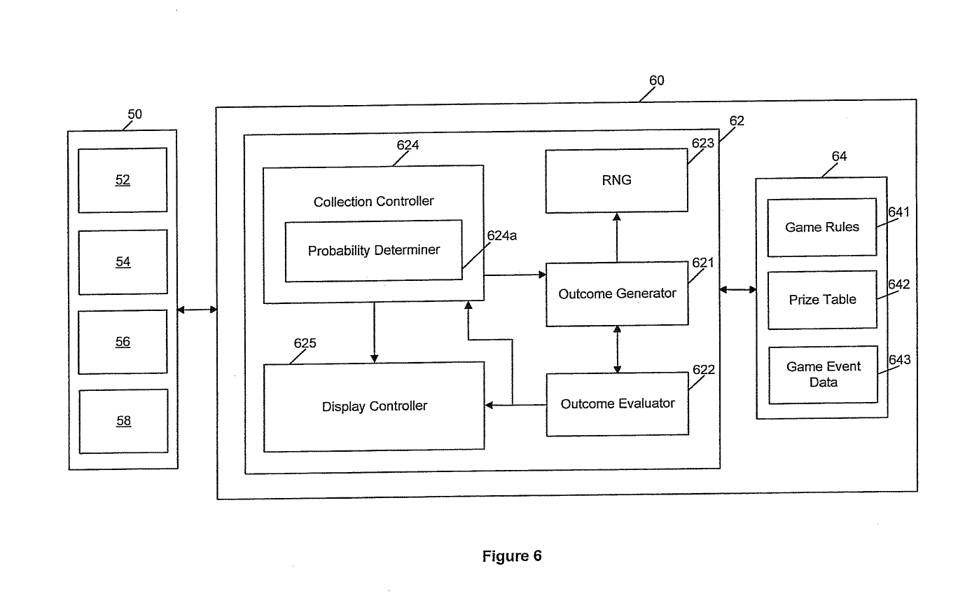

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

### Further Detail of Gaming System

As discussed above, the gaming system is arranged such that the player can collect game events across a plurality of game rounds. Examples, of game events may be a specific symbol occurring in a game round of the game, a specific award being made to the player, a token being awarded to a player instead of an award or as part of an award etc.

The gaming system has a collection controller 624 which conducts, controls, and monitors the collection game. The collection controller 624 is one of a number of modules implemented by processor 62 of game controller 60 based on program code and data stored in memory 64. Persons skilled in the art will appreciate that various of the modules could be implemented in some other way, for example by a dedicated circuit.

The collection controller 624 is arranged to implement a new collection game in response to conditions stored in game rules 641. For example, whenever a new player session is detected, for example when the credit meter changes from zero due to a player adding credit and the player then starts a play of the game. The collection controller 624 also initiates a new collection game when an award is made in a prior collection game.

In the embodiment, game event data 643 is used to store details of game events which occur during the collection game and at the start of a new collection game, collection controller 624 clears any existing game event data 643.

A play of the gaming system is made up of all events which occur subsequent to a player placing a wager and may involve one or more game rounds. A game round involves the generation of a game outcome which is displayed to the player. In the case of a spinning reel game, a game round involves at least one of the reels being “spun”—e.g. new symbols of the reels are selected for display at the display positions and the reel is either physically or virtually spun to a stop. One example of where there may be more than one game round in a play of the gaming system is the case when a series of free spins is awarded. In any individual game round there may be no win or a win(for example from a winning combination of symbols). In the embodiment, each play of the game includes the possibility that that a player may achieve a game event in a game round of the play. Game rules 641 define a number of game events that the player must achieve. The number of game events for a current game round can be set in a number of ways, for example it can be predetermined or selected at random from a plurality of possible values. When the player collects the designated number of game events, the collection controller makes an award to the player which is influenced by the amount wagered on the game round in which the number of game events is achieved.

Persons skilled in the art will appreciate that in some embodiments, more than one game event may be achieved in a game round or only certain game rounds may allow the player to achieve a game event. For example, the player may not be able to achieve a game event during “free games”.

In the embodiment, the player operates the game play mechanism 56 to specify a wager and hence the win entitlement which will be evaluated for each game round of this play of the game and initiates a play of the game. Persons skilled in the art will appreciate that a player's win entitlement may vary from game to game dependent on player selections—i.e. that the player can place different wagers from game to game. In most spinning reel games, it is typical for the player's win entitlement to be affected by the amount they wager and selections they make (i.e. the nature of the wager). For example, a player's win entitlement may be based on how many lines they play in each game—e.g. a minimum of one line up to the maximum number of lines allowed by the game (noting that not all permutations of win lines may be available for selection) and how much they wager per line. Such win lines are typically formed by a combination of symbol display positions, one from each reel, the symbol display positions being located relative to one another such that they form a line.

In many games, the player's win entitlement is not strictly limited to the lines they have selected, for example, “scatter” pays are awarded independently of a players selection of pay lines and are an inherent part of the win entitlement.

Persons skilled in the art, will appreciate that in other embodiments, the player may obtain a win entitlement by selecting a number of reels to play and an amount to wager per reel. Such games are marketed under the trade name “Reel Power” by Aristocrat Leisure Industries Pty Ltd. The selection of the reel means that each displayed symbol of the reel can be substituted for a symbol at one or more designated display positions. In other words, all symbols displayed at symbol display positions corresponding to a selected reel can be used to form symbol combinations with symbols displayed at a designated, symbol display positions of the other reels. For example, if there are five reels and three symbol display positions for each reel such that the symbol display positions comprise three rows of five symbol display positions, the symbols displayed in the centre row are used for non-selected reels. As a result, the total number of ways to win is determined by multiplying the number of active display positions of each reels, the active display positions being all display positions of each selected reel and the designated display position of the non-selected reels. As a result for five reels and fifteen display positions there are 243 ways to win.

In each of the above examples, the awards which the player is eligible for are defined in a prize table 642 which specifies awards for different symbol combinations when they occur on an active win line or an active way to win. These awards are then multiplied by the amount wagered per line or per way. Accordingly, it will be appreciated that the awards (and quantum of them) a player is entitled to depend on the wager.

In the embodiment, the probability of the game event occurring in the current game round is controlled by the collection controller based on the wagers placed in past game rounds where the game event occurred. Advantageously, this enables an award to be provided for the collection game which is affected by an amount wagered in a game round in which the designated number of game events is reached, such as the award of a plurality of game rounds (“free games”) in which the wager of the current play will be applied to the evaluation of each of the plurality of game rounds. If the probability were not controlled, a player could wait until they had nearly completed the collection game and then increase their wager so that when the collection game was completed, the award would be made based upon the increased wager.

In order to control the probability, the collection controller 624 has a probability determiner 624A which determines the probability to apply to a current game round and provides this probability to the outcome generator 622. Initially, the current probability is a base, or unmodified, probability (Pr(x)). The outcome generator 622 operates in response to the player's operation of game play mechanism 56 to place a wager and initiate a play of the game and generates a game outcome based on game rules and the current probability of the designated game event, and a random number obtained from random number generator 623. The game outcome evaluated by outcome evaluator 623 to determine whether the player has achieved any winning outcomes specified in the pay table 642.

One example, of generating a game outcome is to select symbols for display from a plurality of symbol sets corresponding to respective ones of a plurality of spinning reels. The symbol sets 641 can specify a sequence of symbols for each reel such that the symbol selector 622 can select all of the symbols by selecting a stopping position in the sequence. In one example, three symbols of each of five reels may be displayed such that symbols are displayed at fifteen display positions on display 54. In an example, where the game event is the appearance of a symbol or a symbol combination, a probability table stored in memory 64 is used to vary the odds of particular stop positions being selected and the probability of one or more of the stop positions is adjusted. In another embodiment, the game event may be independent of the symbols on the reels so that the occurrence of the game event can be determined by conducting a separate random determination using RNG 621.

When a game event occurs, an entry in made in game event data 643 indicating the amount wagered when the game event occurred.

In one embodiment, in the subsequent game round, the probability is calculated in accordance with the formula:

$$Pr ( {x}_{c} ) = \frac{Pr ( x ) {\sum }_{i = 1}^{n} {B}_{i}}{{nB}_{c}}$$

### Where:

Pr(x_{c}) is the current probability of the game event occurring;
Pr(x) is the unmodified probability of the game event occurring;
n is the number of previously accumulated game events;
Bᵢ is the bet when each of the previously accumulated game events occurred; and
B_{c} is the current bet.

Accordingly, the probability determiner 624a will determine the probability to apply to the current game round. A person skilled in the art will appreciate that the calculation need not be made by the probability determiner 624a each game round but only each time the wager changes and also that the current probability can be stored in game event data 643. That is, each time a wager changes, the probability determiner 624a could update a probability value stored in game event data 643.

Accordingly, the process continues subsequent to the probability being modified with the outcome generator 621 generating a game outcome based on a modified probability of the game event occurring. Accordingly, each time the collection controller is informed by outcome evaluator 622 that a game event has occurred in the game outcome, this is stored to enable probability determiner 624a to adjust the probability based on the wager when the event occurred.

The collection controller 624 also keeps track of the number of game events relative to the number which are designated for a win in the collection game. When the collection game is completed, the collection controller makes the award. In one example, the collection controller 624 makes the award by controlling the outcome generator 621 to generate a plurality of game outcomes with the wager of the previous game. A plurality of game outcomes, is sometimes referred to as a sequence of “free games” by those in the art.

In some embodiments, an eligibility criteria may be applied for the player to participate in the collection game, for example that the player has made a certain sized wager, made an ante bet, selected all win lines, played sufficient games, or the player is a member of a loyalty program.

Persons skilled in the art will appreciate that the award for the collection game can be a feature game involving some additional element of game play. Types of feature games include: those where a series of free game events are awarded such as free games or re-spins (where some reels are held while others are re-spun); games where the symbols on the reel are changed; and “second screen” games where game play is totally different to the base game, for example where the player makes selections in a “pick a box type” game. In a pick a box type game, the number of selections the player receives may be affected by the wager when the player completes the collection game.

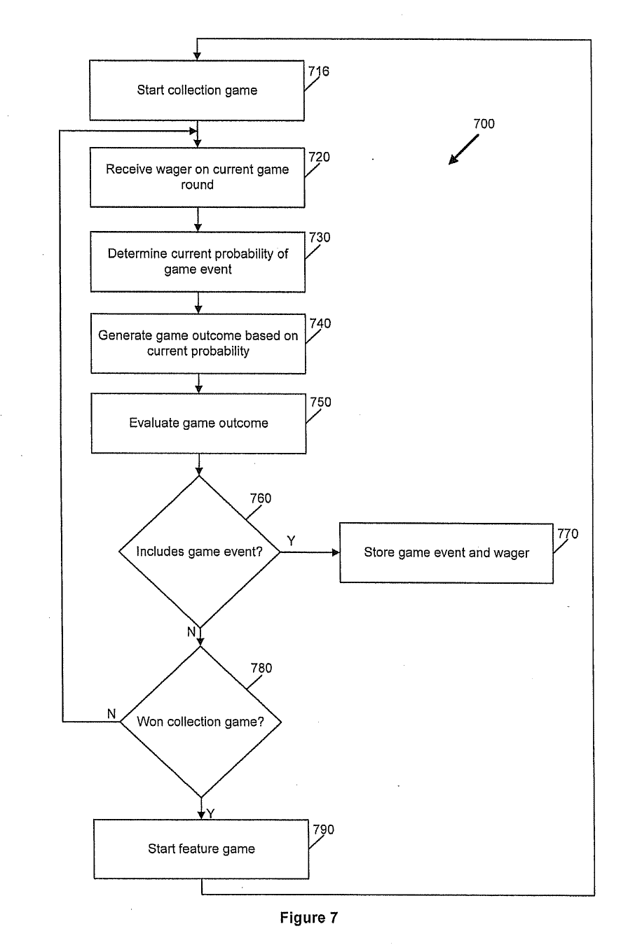

The method of the embodiment is summarized in FIG. 7. The method 700 involves starting a collection game 710. A wager is received on the current game round 720. The current probability of the game event is determined 730. The gaming system then generates a game outcome based on the current probability 740. The game outcome is evaluated 750. If a game event is found in the game outcome 760, the method involves storing details of the game event 770 including the amount wagered on the game event. This allows the probability to be determined in the subsequent game round. It is then determined 780 whether the player has won the collection game. If they have not, the gaming system proceeds to wait for another wager 720. If the player has won the feature game, then in the example of the embodiment, a feature game 790 started in which a series of free game events are conducted for the player with the wager played in the last game.

Further aspects of the method will be apparent from the above description of the system. It will be appreciated that at least part of the method will be implemented digitally by a processor. Persons skilled in the art will also appreciate that the method could be embodied in program code. The program code could be supplied in a number of ways, for example on a tangible computer readable storage medium, such as a disc or a memory (for example, that could replace part of memory 103) or as a data signal (for example, by transmitting it from a server). Persons skilled in the art, will appreciate that program code provides a series of instructions executable by the processor.

### EXAMPLES

### Example 1

In this example the probability of collecting a ball on a game spin is 0.2 and 4 balls, need to be accumulated for a feature to be triggered. Currently the game has 3 balls accumulated and the bets wagered for when these events occurred were 50 cr, 100 cr and 50 cr. The player is currently betting 200 cr and so in order to calculate the probability of the 4^{th} ball being collected we would need to implement the formula shown above.

Assigning values to variables:

### Pr(x)=0.2

n=3

### B₁=50

### B₂=100

### B₃=50

### B_{c}=200

Adding these values into the formula:

$$Pr ( {x}_{c} ) = \frac{0.2 * ( 50 + 100 + 50 )}{3 * 200} = 0.06667$$

Thus the probability of the 4^{th} ball being collected in this scenario is 0.06667.

### Example 2

In this example the probability of collecting a ball on a game spin is 0.3 and 6 balls need to be accumulated for a feature to be triggered. Currently the game has 5 balls accumulated and the bets wagered for when these events occurred were 50 cr, 100 cr, 150 cr, 50 cr and 200 cr. The player is currently betting 50 cr and so in order to calculate the probability of the 6th ball being collected we would need to implement the formula shown above.

Assigning values to variables:

$$Pr ( x ) = 0.32$$

$$n = 5$$

$${B}_{1} = 50$$

$${B}_{2} = 100$$

$${B}_{3} = 150$$

$${B}_{4} = 50$$

$${B}_{5} = 200$$

$${B}_{c} = 50$$

$$Pr ( {x}_{c} ) = \frac{0.3 * ( 50 + 100 + 150 + 50 + 200 )}{5 * 50} = 0.66$$

Thus the probability of the 6th ball being collected in this scenario is 0.66.

### Example 3

In Example 3, Pr(x) is not constant for all the previously accumulated game events

In this scenario Pr(x_{c}) would need to be calculated considering the Pr(xᵢ) of each of the accumulation related game events respective to their corresponding bets. To this end, in addition to the wager being stored in game event data, the probability is also stored as game event data 643 and the current probability is calculated in accordance with the formula:

$$Pr ( {x}_{c} ) = {\sum }_{i = 1}^{n} \frac{Pr ( {x}_{i} ) B}{{nB}_{c}}$$

That is, above Examples 1 and 2 have been simplified to the case where the probability has not been varied in previous games. A person skilled in the art will appreciate that if the wagers change, it may be necessary to alter the probability from time to time based on the probabilities of specific games as well as the wager.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of gaming in a gaming system, the method comprising:
conducting a game event collection game in which a player seeks to collect a designated number of a game event across a plurality of game rounds conducted with the gaming system to thereby obtain an award affected by an amount wagered in a game round in which the designated number of game events is reached;
storing data in a memory of the gaming system in response to occurrence of the game event in a game round, the data enabling a determination of an average amount wagered in respect of each game round in which a game event occurred;
generating a game outcome for each game round by controlling a probability of the game event occurring in each game round by determining a current probability of the game event occurring to apply to a current game round, wherein (i) prior to a game event occurring, the current probability is determined to be a base probability; and (ii) subsequent to a game event occurring, the current probability is determined based on an amount wagered in respect of the current game round and the average amount wagered; and
making the award upon the designated number of game events being reached.

2. A method as claimed in claim 1, comprising determining whether to make one or more other awards in respect of each game outcome.

3. A method as claimed in claim 1, wherein the award comprises conducting a series of free game rounds and determining whether to make any free game round awards, wherein the quantum of each free game round award is affected by the amount wagered in the game round in which the designated number of game events were collected.

4. A method as claimed in claim 3, wherein the free game rounds are different to the game rounds in which the game events are collected.

5. A method as claimed in claim 1, wherein the quantum of the award is affected by the amount wagered in a game round in which the designated number of game events is reached.

6. A method as claimed in claim 1, wherein the step of storing data comprises storing each amount wagered when a game event occurred to thereby enable the average amount wagered to be determined.

7. A method as claimed in claim 1, wherein the step of storing data comprises determining and storing an updated average amount wagered in response to each game event occurring.

8. A method as claimed in claim 1, wherein the step of storing data further comprises storing the current probability when a game event occurred and wherein the step of determining the current probability subsequent to a game event occurring is based on the current probability is performed based on the stored current probability data.

9. A method as claimed in claim 1, comprising initiating a new game event collection game in response to making the award.

10. A game controller for a gaming system, the game controller arranged to:
conduct a game event collection game in which a player seeks to collect a designated number of a game event across a plurality of game rounds conducted with the gaming system to thereby obtain an award affected by an amount wagered in a game round in which the designated number of game events is reached;
store data in a memory of the gaming system in response to occurrence of the game event in a game round, the data enabling a determination of an average amount wagered in respect of each game round in which a game event occurred;
generate a game outcome for each game round by controlling a probability of the game event occurring in each game round by determining a current probability of the game event occurring to apply to a current game round, wherein (i) prior to a game event occurring, the current probability is determined to be a base probability; and (ii) subsequent to a game event occurring, the current probability is determined from the base probability, an amount wagered in respect of the current game round, and the average amount wagered; and
make the award upon the designated number of game events being reached.

11. A game controller as claimed in claim 10, arranged to determine whether to make one or more other awards in respect of each game outcome.

12. A game controller as claimed in claim 10, wherein the award comprises the game controller conducting a series of free game rounds and determining whether to make any free game round awards, wherein the quantum of each free game round award is affected by the amount wagered in the game round in which the designated number of game events were collected.

13. A game controller as claimed in claim 12, wherein the free game rounds are different to the game rounds in which the game events are collected.

14. A game controller as claimed in claim 10, wherein the quantum of the award is affected by the amount wagered in a game round in which the designated number of game events is reached.

15. A game controller as claimed in claim 10, wherein the game controller stores each amount wagered when a game event occurred to thereby enable the average amount wagered to be determined.

16. A game controller as claimed in claim 10, wherein the game controller stores data by determining and storing an updated average amount wagered in response to each game event occurring.

17. A game controller as claimed in claim 10, wherein the game controller stores the current probability when a game event occurred and the game controller determines the current probability subsequent to a game event occurring based on the stored current probability data.

18. A game controller as claimed in claim 10, arranged to initiate a new game event collection game in response to making the award.

19. A gaming system comprising:
a display;
a memory;
a collection controller arranged to:
conduct a game event collection game in which a player seeks to collect a designated number of a game event across a plurality of game rounds conducted with the gaming system to thereby obtain an award affected by an amount wagered in a game round in which the designated number of game events is reached,
store data in the memory of the gaming system in response to occurrence of the game event in a game round, the data enabling a determination of an average amount wagered in respect of each game round in which a game event occurred, and
make the award upon the designated number of game events being reached;
a probability determiner arranged to determine a current probability of a game event occurring to apply to a current game round, wherein (i) prior to a game event occurring, the current probability is determined to be a base probability; and (ii) subsequent to a game event occurring, the current probability is determined from the base probability, an amount wagered in respect of the current game round, and the average amount wagered; and
an outcome generator arranged to generate a game outcome based on the current probability of the game event occurring for display on the display.

20. A gaming system as claimed in claim 19, comprising an outcome evaluator arranged to determine whether to make one or more other awards in respect of each game outcome.

21. A gaming system as claimed in claim 19, wherein the award comprises the outcome generator conducting a series of free game rounds and the outcome evaluator determining whether to make any free game round awards, wherein the quantum of each free game round award is affected by the amount wagered in the game round in which the designated number of game events were collected.

22. A gaming system as claimed in claim 21, wherein the free game rounds are different to the game rounds in which the game events are collected.

23. A gaming system as claimed in claim 19, wherein the quantum of the award is affected by the amount wagered in a game round in which the designated number of game events is reached.

24. A gaming system as claimed in claim 19, wherein the collection controller stores each amount wagered when a game event occurred to thereby enable the average amount wagered to be determined.

25. A gaming system as claimed in claim 19, wherein the collection controller stores data by determining and storing an updated average amount wagered in response to each game event occurring.

26. A gaming system as claimed in claim 19, wherein the collection controller stores the current probability when a game event occurred and the probability determiner determines the current probability subsequent to a game event occurring based on the stored current probability data.

27. A gaming system as claimed in claim 19, arranged to initiate a new game event collection game in response to making the award.

28. A gaming system comprising:
means for conducting a game event collection game in which a player seeks to collect a designated number of a game event across a plurality of game rounds conducted with the gaming system to thereby obtain an award affected by an amount wagered in a game round in which the designated number of game events is reached;
means for storing data in a memory of the gaming system in response to occurrence of the game event in a game round, the data enabling a determination of an average amount wagered in respect of each game round in which a game event occurred;
means for generating a game outcome for each game round by controlling a probability of the game event occurring in each game round by determining a current probability of the game event occurring to apply to a current game round, wherein (i) prior to a game event occurring, the current probability is determined to be a base probability; and (ii) subsequent to a game event occurring, the current probability is determined from the base probability, an amount wagered in respect of the current game round, and the average amount wagered; and
means for making the award upon the designated number of game events being reached.

29. A method as claimed in claim 1, and further comprising executing computer program code.
